(19) United States
(12) Patent Application Publication
(10) Pub. No.: US 2005/0284386 A1
(43) Pub. Date: Dec. 29, 2005

(54) In-line feed supplement adding system

(76) Inventors: Brad Eversole, Tower Hill, IL (US); Thomas D. Fleshner, Shelbyville, IL (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 10/861,185

(22) Filed: Jun. 4, 2004

(51) Int. Cl. A01K 5/02

(52) U.S. Cl. 119/57.1

(57) ABSTRACT

An in-line feed supplement additive system comprises an additive hopper which can be disconnected from the feed line of a feed system and inverted to allow for cleaning of the additive hopper. The system includes a controller which, determines the proper speed of the motor which drives the conveyor of the additive hopper based upon the dosage of the additive and the flow rate of feed through the feed line. Further, the controller monitors the load on the additive hopper motor during delivery of additive to ensure a substantial constant rate of delivery of additive to said feed.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

This invention relates to animal feed systems, and, in particular, to a system for the in-line addition of supplements or additives (such as medication, vitamins, minerals, etc.) to dry feed.

Animal feed for farm animals (i.e., poultry, hogs, cows, etc.) is usually purchased in bulk. If any of the animals need to be medicated, or if the farmer requires that vitamins, minerals, or other additives or supplements be added to the food, the farmer has to have the supplements added to the feed at the feed mill. The feed mill will then provide the farmer with a feed bag containing feed which will last a defined period of time.

Feed pre-mixed with supplements requires special batch operations by the feed mill, and hence adds cost to the feed. Additionally, if more feed/supplement mix than is needed is provided, the remainder of the feed/supplement mix could be wasted.

It would be beneficial to provide a system whereby additives or supplements, such as medicaments, vitamins, minerals, etc. can be added to the feed at the farm, where the farmer will have more control over the feed mixture and the feeding of his animals.

### BRIEF SUMMARY OF THE INVENTION

In accordance with the invention, generally stated, a supplement additive system is provided to add a supplement to the feed line of a feed system while feed is being delivered to feed pens. As is known, a feed system comprises a feed hopper, at least one feed bin and the feed line which delivers feed from the feed hopper to the feed bin. A feed conveyor, often in the form of an auger, delivers feed from the feed hopper to the feed bin. The feed conveyor is driven by a feed motor.

In accordance with one aspect of the invention, the system includes a feed additive hopper assembly which comprises an additive hoper having an opening at a top thereof and an outlet at the bottom thereof, an outlet or drop tube having a first end in fluid communication with the hopper outlet, and a connector for connecting the outlet tube to the feed line. A mounting bracket is provided for mounting the additive hopper to a surface. The bracket is adapted to be mounted to a surface and includes a pair of opposed arms to which the additive hopper is mounted. The connection of the additive hopper to the bracket arms allows for the additive hopper to pivot relative to the bracket arms. The additive hopper can pivot between a first position in which the hopper is upright and a second position in which the hopper is inverted. A lock, in the form of a knob, is provided to maintain the hopper in its desired orientation. The knob includes a shaft which extends through the bracket arm to operatively engage the side of the additive hopper. The lock is movable between a first position in which the lock engages the additive hopper to secure the additive hopper in a desired position, and a second position in which the additive hopper can be pivoted in the bracket. Preferably, a pivot plate is provided. The pivot plate is mounted to the sides of the hopper, and is used to mount the additive hopper within the bracket.

In accordance with another aspect, the additive hopper outlet tube is removably connected to either or both of the connector assembly and the additive hopper outlet. The connector assembly comprises a saddle sized and shaped to be fitted over the feed delivery tube of a feed delivery system. The saddle is generally C-shaped in end elevation and is being sized and shaped to be snap fit over the feed delivery tube. The connector assembly and said hopper outlet each comprise necks. The outlet tube being sized and shaped to mate with said connector assembly and outlet necks to be removable secured there, for example, by means of hose clamps. The snap connection of the saddle to the feed line also allows for removal of the saddle from the feed line.

In operation, additive or supplement contained within the additive hopper is introduced into the feed line through the additive hopper outlet tube. The additive hopper includes a conveyor, preferably in the form of an auger, which delivers additive contained within the additive hopper to the additive hopper outlet. The additive hopper conveyor is driven by an additive hopper motor. The additive then passes through the outlet tube and enters the feed line. The feed line is of a sufficient length and the feed conveyor is sized and shaped such that the additive is thoroughly mixed with the feed by the time the additive and feed mixture reaches the feed bin.

The in-line additive delivery system is provided with a control system which controls the feed motor and the additive hopper motor and which controls the speed of the additive hopper motor. The control system comprises a controller which is operatively connected to the additive hopper motor to be able to activate and deactivate the additive hopper motor. A relay is interposed between the controller and the feed motor, and the controller sends signals to the relay to activate and deactivate the feed motor. A feed sensor proximate the feed hopper detects the flow of feed from the hopper and emits a signal when feed stops flowing from the feed hopper. The signal from the feed sensor would indicate that either the feed hopper is empty or that a bridge condition exists in the feed hopper. A feed bin sensor can also be provided to send a signal to the controller when the bin is filled to a determined level with feed.

In accordance with one aspect of the control system, the feed hopper sensor will sends a signal to the controller when it is determined that the feed hopper is empty or that a bridge condition exists in said feed hopper. In response to this signal, the controller will deactivate said additive hopper motor to prevent additive from being delivered to the feed bin without being mixed with feed. When the feed hopper sensor determines that the error condition has been corrected (i.e., that the feed hopper has been refilled, or that the bridge condition has been removed), and feed is once again flowing through the feed line, the controller will reactivate the additive hopper motor.

When the feed bin has been filled to the predetermined level, the feed bin sensor will sends a signal indicative of such to the controller. The controller can then deactivate only the feed additive motor, if there are additional bins to fill with feed, and it is desired to provide additive only to the first feed bin. Alternatively, the controller can deactivate both the feed motor and the additive hopper motor.

The control system also determines the appropriate speed of the additive hopper motor (or the appropriate speed of the additive hopper conveyor) required to attain the proper dosage (D) of the additive based on the flow rate F_{f} of the feed through the feed line. In a first step for determining the desired speed RPMᵣ of the additive motor, the flow rate F_{f} of the feed from said feed hopper to said feed bin in units of wt/time is determined. This can be done manually, and then input into the controller, or automatically. The flow rate Fₐ of the additive from the additive hopper in units of wt/time at a predetermined speed RPMₐ of the additive motor is also determined. This additive flow rate Fₐ can be determined manually, automatically, or derived from a chart. The required speed RPMᵣ of the additive hopper motor is determined according to the following equation:
RPMᵣ=(D*F_{f}*RPMₐ)/Fₐ.

The controller than adjusts the speed of the additive hopper motor to drive the additive motor at the desired speed RPMᵣ. The controller also monitors the load on the additive motor and adjust the speed of the additive motor based upon changes in the load of the additive motor to maintain a substantially constant rate of delivery of additive to the feed. This helps ensure that additive is delivered to the feed at a substantially constant rate to help ensure that the proper dosage D of the additive is obtained. The load on the additive motor can be monitored by the electrical current used by the motor to drive the additive conveyor; by monitoring the torque required by the motor to drive the additive conveyor; or by monitoring the rate of movement of additive feed conveyor. Preferably, the load on the additive hopper motor is monitored by monitoring the speed of the motor output shaft. If the speed of the motor output shaft varies, the controller will adjust the voltage supplied to the additive hopper motor to control the speed of the motor.

In accordance with another aspect of the invention, a method of controlling the in-line supplement delivery system for adding a supplement to a feed line of a feed delivery system is disclosed. The method comprises establishing an actual flow output rate of the feed delivery system; establishing a first flow output rate of the additive delivery system; and determining a second flow output rate for the additive delivery system based on the established flow rates of the feed and additive delivery systems and a desired dosage for the additive. The additive hopper motor is then run at this second flow rate. The step of establishing the first flow rate of the additive delivery system comprises obtaining a value from a chart of flow rates for specific additives or it can be an actual flow rate. Establishing of actual flow rates (for either the feed delivery system or the additive delivery system) can be accomplished manually or automatically. If determined automatically, an electronic timer and scale can be provided with the system to determine the actual flow rates or the flow rates can be determined on-the-fly using known flow rate measuring equipment. In either case, the automatic system would provide the established rates to the controller for determination of the second flow rate for the additive delivery system.

Additionally, the method can comprise a step of checking the actual flow rates of either or both of the feed delivery system and/or the additive delivery system. If the flow rate of either the feed delivery system or the additive delivery system has changed, the speed at which the additive delivery system drive is operated can be adjusted to compensate for the changes to (1) maintain the second flow rate of the additive delivery system at a substantially constant rate and (2) to ensure that the proper additive dosage is maintained.

### BRIEF DESCRIPTION OF THE SEVERAL VIEWS OF THE DRAWINGS

FIG. 1 is a schematic drawing of an in-line supplement adding system of the present invention;

FIG. 1A is an exploded view of the in-line supplement adding system of the present invention;

FIG. 2 is a block diagram of the controls for the supplement adding system;

FIG. 2A is a wiring diagram for the electrical components of the control system;

FIG. 2B is a flow chart of the operation of controller in activating and deactivating the feed motor and additive hopper motor

FIG. 2C is a flow chart of the control of the speed of the additive hopper motor;

FIG. 3 is a perspective view of a feed hopper with an additive hopper of the present invention;

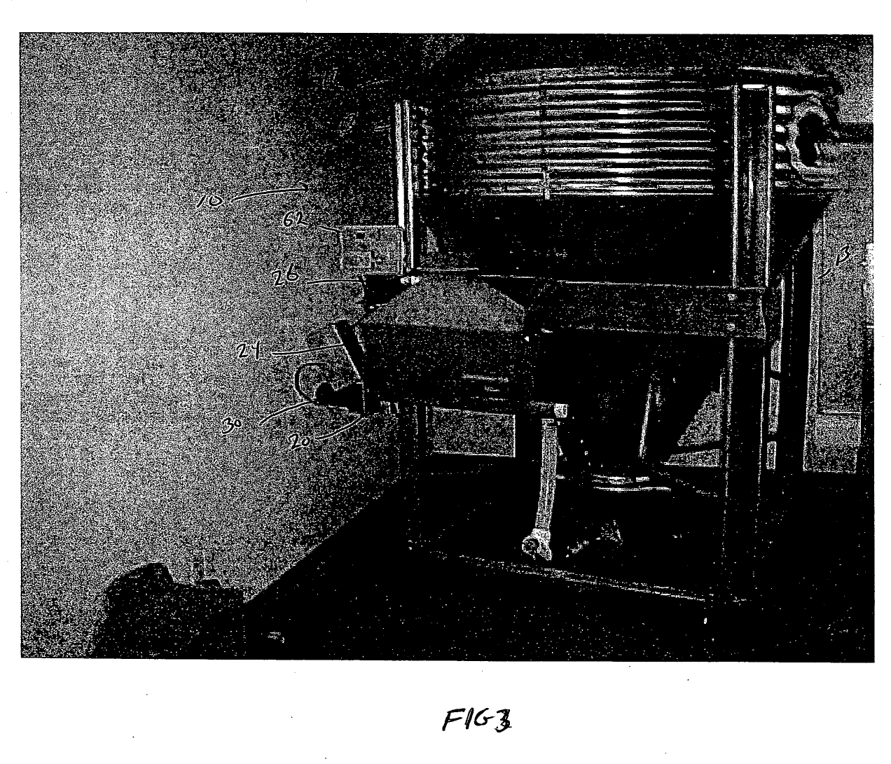

FIG. 4 is a side elevational view of the additive hopper mounted to the frame of the feed hopper

FIG. 5 is an enlarged view of the additive hopper of the supplement adding system;

FIG. 6 is an enlarged view of the additive hopper, showing the additive hopper in an inverted position;

FIG. 7 is a side perspective view of the additive hopper in an inverted position;

FIG. 8 is a top perspective view of the additive hopper and its mounting bracket;

FIG. 9 is a top plan view of the additive hopper interior showing the auger of the additive hopper; and

FIG. 10 is a plan view of the control panel for the supplement adding system.

Corresponding reference numerals will be used throughout the several figures of the drawings.

### DETAILED DESCRIPTION OF THE INVENTION

The following detailed description illustrates the invention by way of example and not by way of limitation. This description will clearly enable one skilled in the art to make and use the invention, and describes several embodiments, adaptations, variations, alternatives and uses of the invention, including what we presently believe is the best mode of carrying out the invention. Additionally, it is to be understood that the invention is not limited in its application to the details of construction and the arrangements of components set forth in the following description or illustrated in the drawings. The invention is capable of other embodiments and of being practiced or being carried out in various ways. Also, it is to be understood that the phraseology and terminology used herein is for the purpose of description and should not be regarded as limiting.

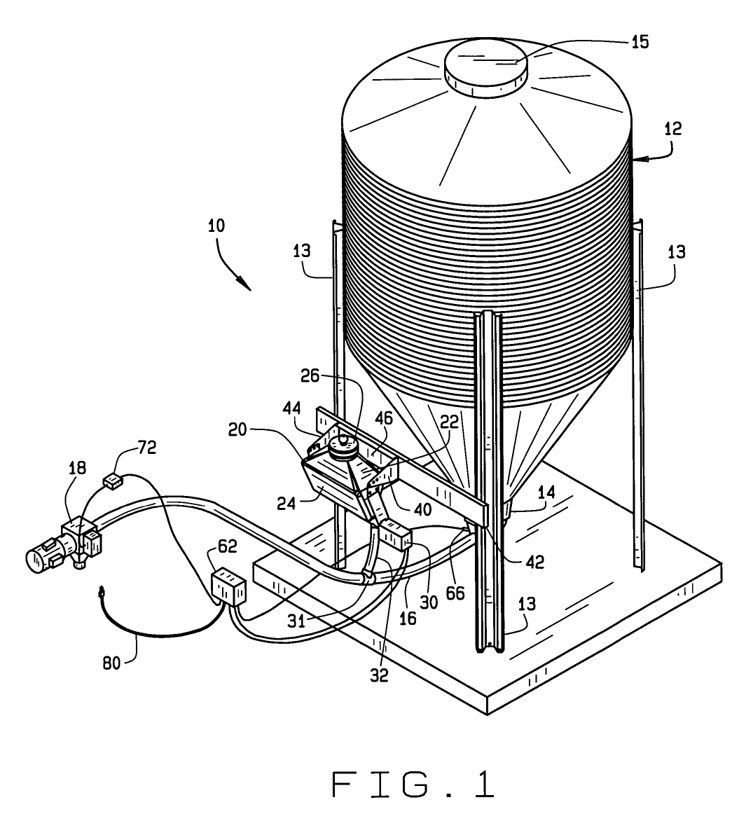

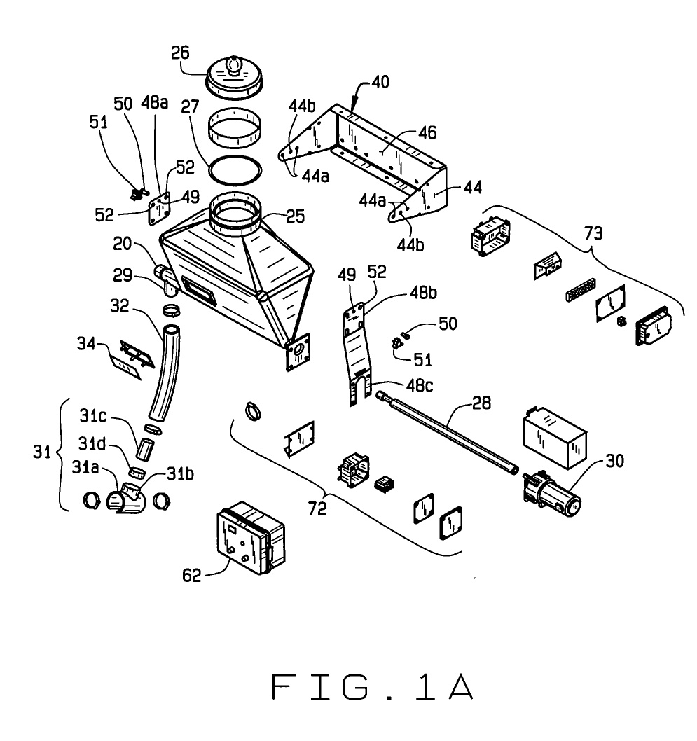

A feed additive mixing system 10 of the present invention is shown generally in FIG. 1. The additive mixing system 10 comprises a feed hopper 12 which is supported above the ground by legs 13. The hopper 12 has an opening at its top which is covered by a lid 15. The hopper 12 also has an outlet 14 at its bottom which delivers feed into a delivery tube 16. A conveyor (not shown) is contained within the delivery tube 16 to deliver feed from the hopper to a feed bin for consumption of the feed by an animal. The feed conveyor is operated by a feed conveyor motor 18. The feed motor 18 can be either a single speed motor or a variable speed motor. The feed conveyor is preferably an auger. However, the conveyor can also be chain conveyor or any other type of conveyor system which will move the feed through the conduits 16 from the feed hopper 12 to feed bins.

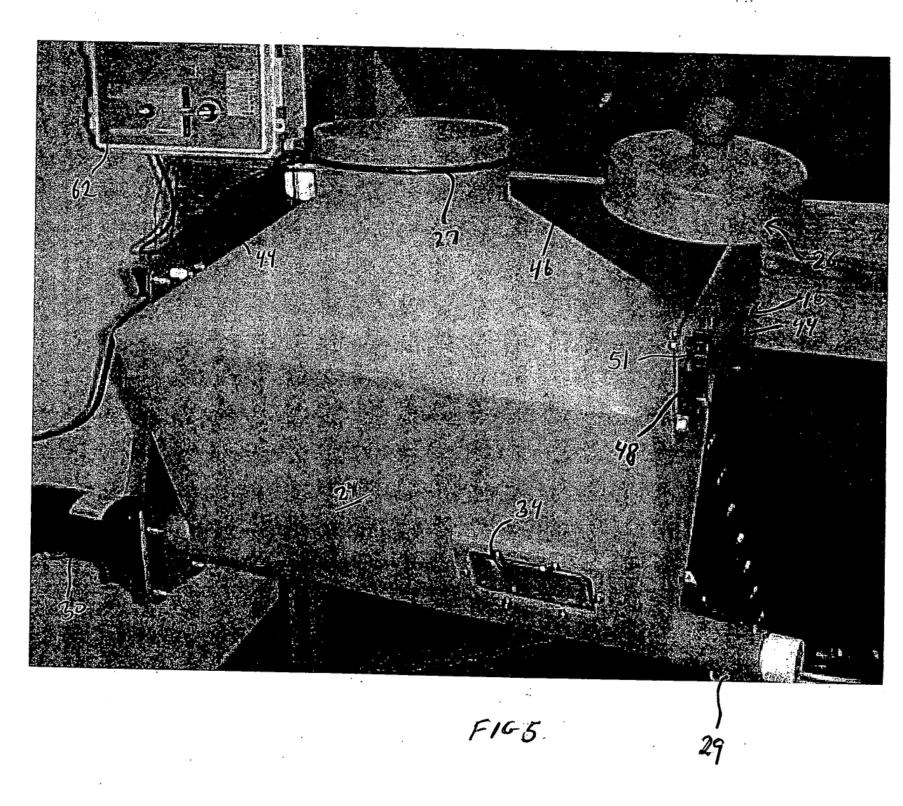

The supplement adding system 10 also includes a supplement or additive hopper 20 which holds dry additives such as medicaments, vitamins, minerals, or any other item which may be desired to be added to the feed which is delivered to the feed bins by means of the conveyor within the delivery tube 16. The hopper 20 includes side walls 22 and front and back walls 24. The side walls 22 each include upper and lower sections in the shape of truncated triangles which are joined at the bases of the triangles to give the hopper the appearance of a truncated diamond in side elevation. The front and back walls, in turn, have upper and lower sections which slope inwardly, such that the hopper 20 has a widest width at its middle and narrows in width towards both the top and bottom. The top of the hopper 20 includes a neck 25 forming an opening which is closed by a lid 26. As seen in FIG. 5, the neck 25 has an O-ring or other seal 27 which seals with the lid 26 when the lid is placed over the neck opening.

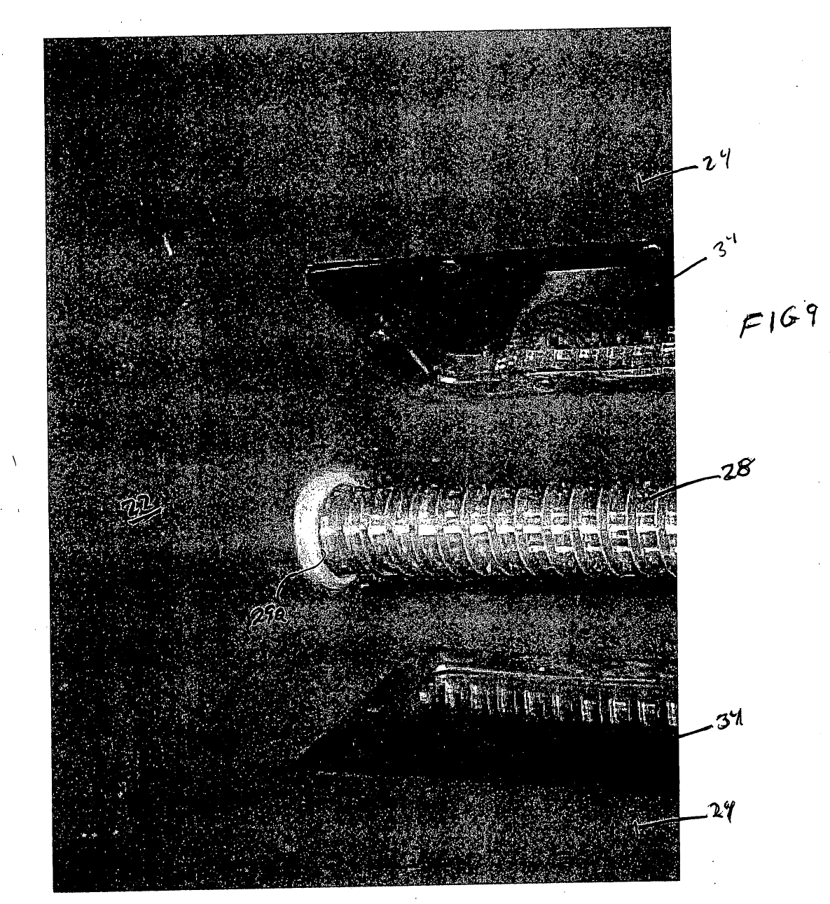

An auger 28 (FIG. 9) is provided at the bottom of the hopper. The auger 28 is rotated by a motor 30 to deliver the additive contained within the hopper 20 to an outlet 29. The motor 30 is preferably a variable speed motor, such that the speed of the auger 28 can be varied, as described below. A drop tube 32 fluidly connects the hopper outlet 29 to the feed delivery tube 16. As seen in FIG. 1A, the additive hopper outlet 29 defines a tube extending downwardly from a bottom of hopper 20. The drop tube 32 is sized to be fitted over the outlet 29 and is preferably removably connected to the outlet 29. For example, the drop tube 32 can be connected to the outlet 29 by means of a hose clamp.

As seen in FIG. 9, the side wall 22 includes an outlet opening 29a through which the auger 28 extends. The outlet opening 29a has a diameter approximately equal to the outer diameter of the auger 28 to control the delivery of additive from the hopper 20. With the outlet opening 29a being approximately equal to the outer diameter of the auger, only feed that is captured between the auger flights will be delivered through the outlet opening 29a, to the outlet 29, and then to the feed delivery tube 16 by way of the drop tube 32. As can be appreciated, the sloped shape of the bottom portion of the hopper 20 directs the additives within the hopper 20 towards the auger as additive is delivered from the hopper. The operation of the auger 28 and the fill condition of the hopper 20 (i.e., whether the hopper is empty, if a bridging condition exists, etc.) can be seen through windows 34 in the hopper's front and back walls 24.

The additive hopper drop tube 32 is in communication with the feed delivery tube 16, such that the additive contained within the additive hopper 20 will be delivered into the feed delivery tube 16. The rotation of the auger within the feed delivery tube 16, mix the additive with the feed. The feed delivery tube has a length, and the feed auger is shaped, such that the additive will be thoroughly mixed with the feed at the point the feed/additive mixture is delivered to a feed bin.

To allow for simple connection of the drop tube 32 to the feed tub 16, the additive drop tube 32 is provided, at its free end, a connector assembly 31. The connector assembly 31 includes a generally C-shaped saddle 31a having a neck 31b which receives the end of the drop tube 32. The saddle 31a is, as just noted, in the shape of a C, and is of a thickness to be at least slightly flexible so that the saddle can be snap fit over the feed delivery tube 16. The saddle 31a can be held in place on the feed tube 16 by means of hose clamps if desired. The saddle 31a includes an opening which into which the neck 31b opens, and which is aligned with an opening (not shown) in the feed tube 16. An extender tube 31c is received in the saddle neck 31b, and the end of the drop tube 32 is connected to the extender tube 31c. Again, a hose clamp can be used to connect the drop tube 32 to the connector extender tube 31c. Lastly, the connector assembly can be provided with a reducer 31d which is positioned in the saddle neck 31b. If desired, the reducer 31d can be permanently affixed in the saddle neck 31b, and the extender tube 31c can be permanently affixed to the reducer 31d. If desired, the saddle 31a can be provided with sealing elements to provide a seal between the saddle 31a and the feed delivery tube 16 to prevent foreign matter or moisture from entering the feed delivery tube. As will be discussed in below, when the additive is added to the feed delivery tube, the auger within the feed delivery tube 16 will mix the additive with the feed so that, by the time the feed reaches the bin, the additive will be thoroughly mixed with the feed.

The provision of the snap-on saddle allows for simple connection of the drop tube to the feed line. It also allows for simple disconnection of the saddle from the feed line if desired. Additionally, the drop tube 32 is not permanently fixed to either the additive hopper outlet 29 or to the connector assembly extender tube 31c. Hence, the drop tube 32 can be easily disconnected from either the connector assembly 31 or the additive hopper 20 or from both when necessary for cleaning or replacing.

The additive hopper 20 is shown in FIG. 1 to be mounted to the feed hopper legs 13. However, the additive hopper 20 could be remote from the feed hopper if so desired. As shown, the feed hopper 20 is supported in a bracket 40 which is mounted to a support 42, which, in turn, extends between, and is fixed to, a pair of the hopper legs 13. The support 42 can be a wooden plank which is mounted to the legs or a metal member which is preformed to include openings through which bolts can extend to secure the bracket 40 to the support 42.

The hopper bracket 40 includes a pair of arms 44 which extend generally perpendicularly from, and are spaced apart by, a back plate 46. The arms are shown to be generally triangular in shape, and narrow towards the front of the arms. The back plate 46 includes a plurality of openings through which bolts or other fastening elements can extend to mount the bracket 40 to the support 42. The bracket arms 44 include two openings 44a and an opening 44b between the openings 44a. The centers of the three openings define a generally straight line, and are positioned near the forward and of the arms 44.

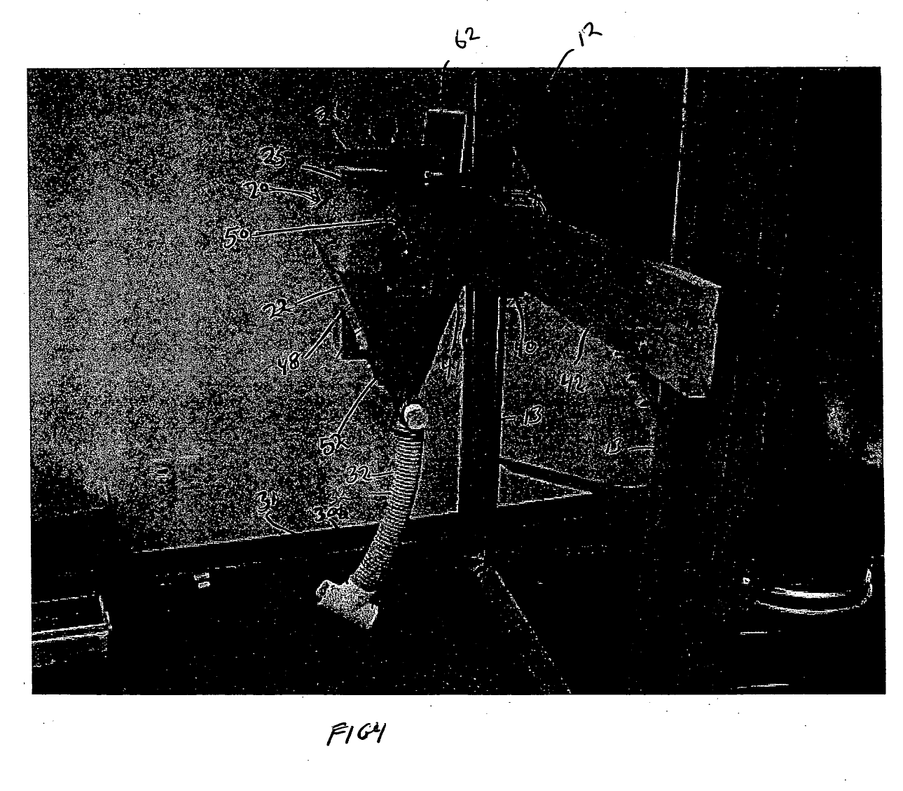

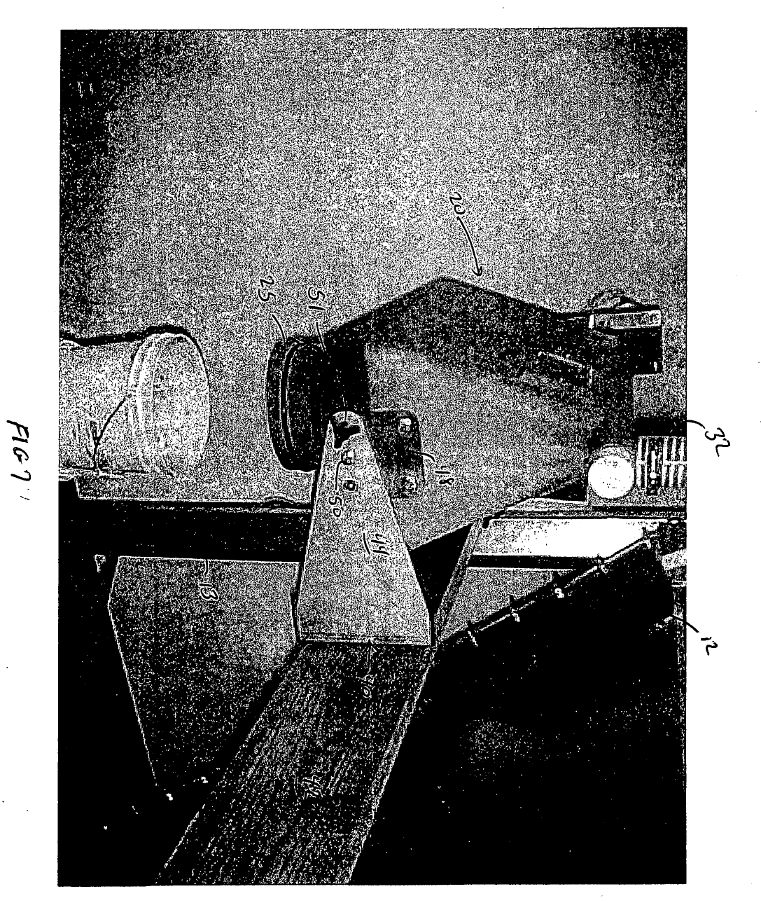

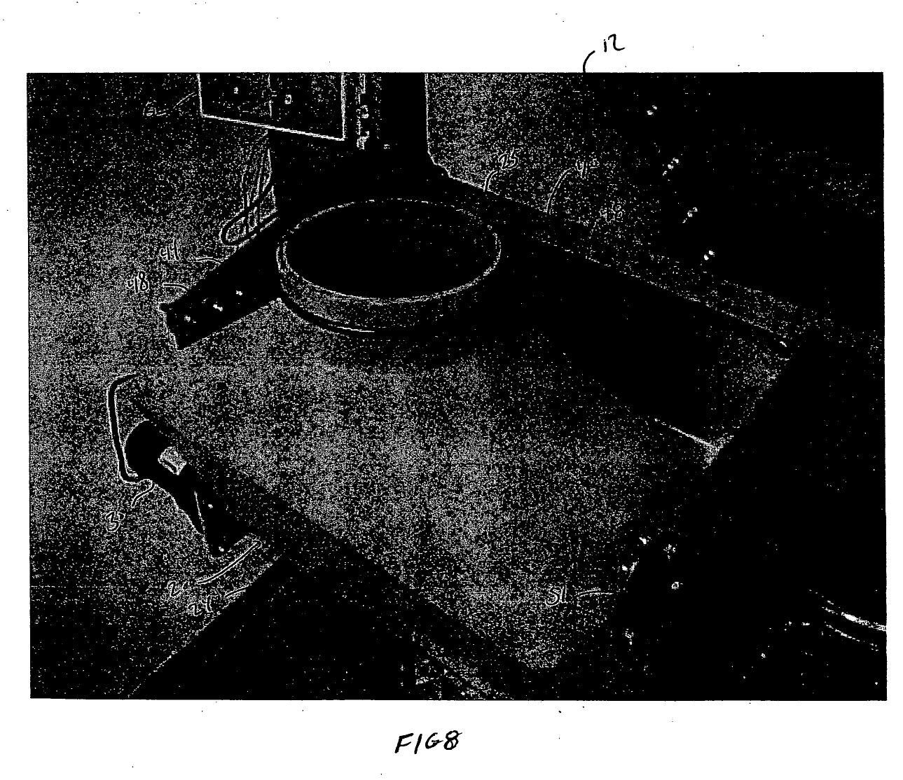

As seen best in FIGS. 4-8, side pivot plates 48a,b are secured to the hopper side walls 22 by any conventional means. As seen, the pivot plate 48b is connected to the motor side of the hopper 20, and extends to the bottom of the hopper. The plate 48b also include a motor mounting plate 48c to which the hopper motor 30 is mounted.

The pivot plates 48a,b include a pair of outer openings 52 and a central opening 49 which are generally co-linear openings and are positioned to align with the bracket arm openings 44a,b. The two outer openings 52 include small projections, as seen in FIG. 1A, which are sized to be received in the openings 44a of the bracket arms 44. A pin 50 extends through the pivot plate center opening 49 into the bracket arm center opening 44b. The pin attachment of the plates 48 to the bracket arms 44 allow for the hopper 20 to pivot about the pins 50. In addition, a knob 51 extends through one of the outer pivot plate openings 49 and into one of the outer bracket arm openings 44a. The arm includes a threaded shaft, and can be tightened down to secure the hopper in a desired angular position. By loosening the knob 51, the hopper 20 can be inverted and secured in an inverted position by retightening the knob 51.

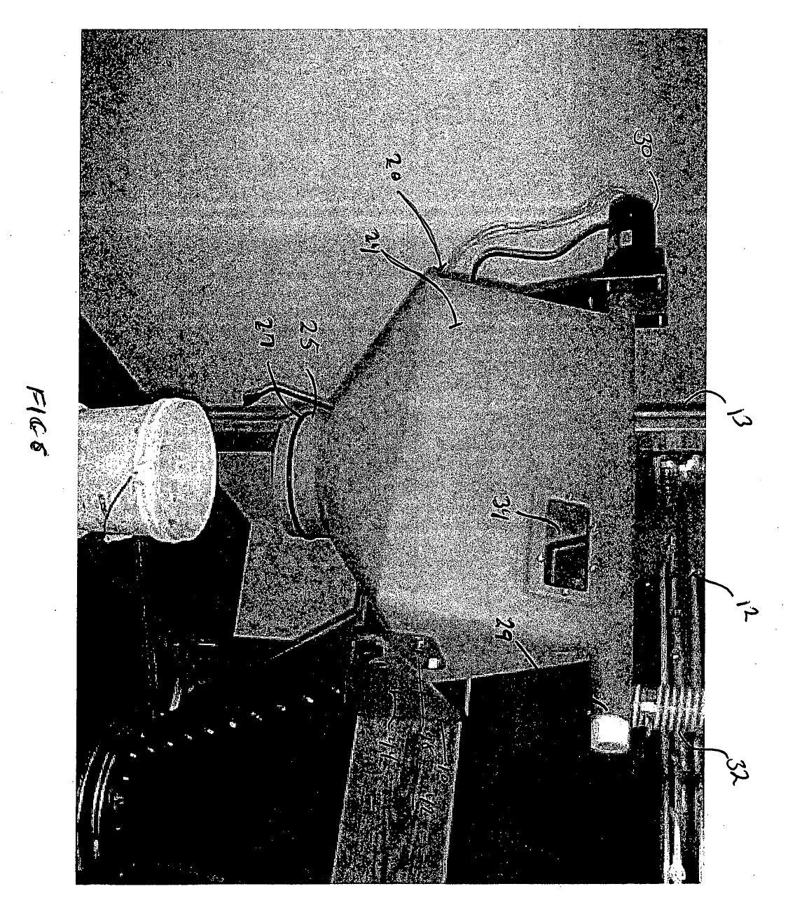

To maintain the hopper in a vertical position, for example, as seen in FIG. 4, at least one of the bracket arms 44 (and preferably both of the bracket arms) are provided with holes 52 on opposite sides of the pin 50. To maintain the additive hopper in its vertical position (and to prevent the additive hopper from rocking) a bolt 54 extends through the aligned openings in the bracket arm and side pivot plate, and is threaded into a nut on the inner surface of the pivot plate. The two holes in the pivot plate are spaced apart from the pin by an equal distance, such that, when the hopper is pivoted to an inverted position, as seen in FIG. 6, the bolt 54 can be used to maintain the additive hopper 20 in its inverted position.

As can be appreciated, the ability to invert the hopper 20 allows for the additive hopper to be emptied. The ability to empty and clean the hopper is important. When a new additive is to be placed in the additive hopper 20, it may be necessary to ensure that the additive hopper 20 has been emptied of the additive which was previously in the hopper 20. This is typically important when the additives are medicines. As can be appreciated from the above description, the ability to disconnect the additive hopper 20 from the feed line 16 and the ability to invert the hopper 20 makes emptying and cleaning of the hopper 20 easier.

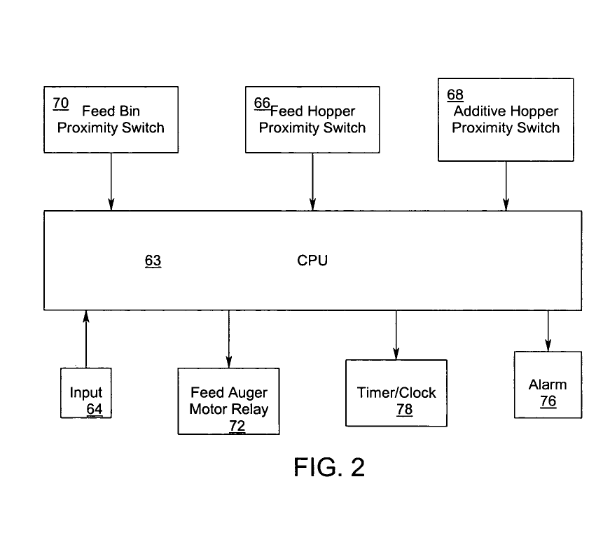

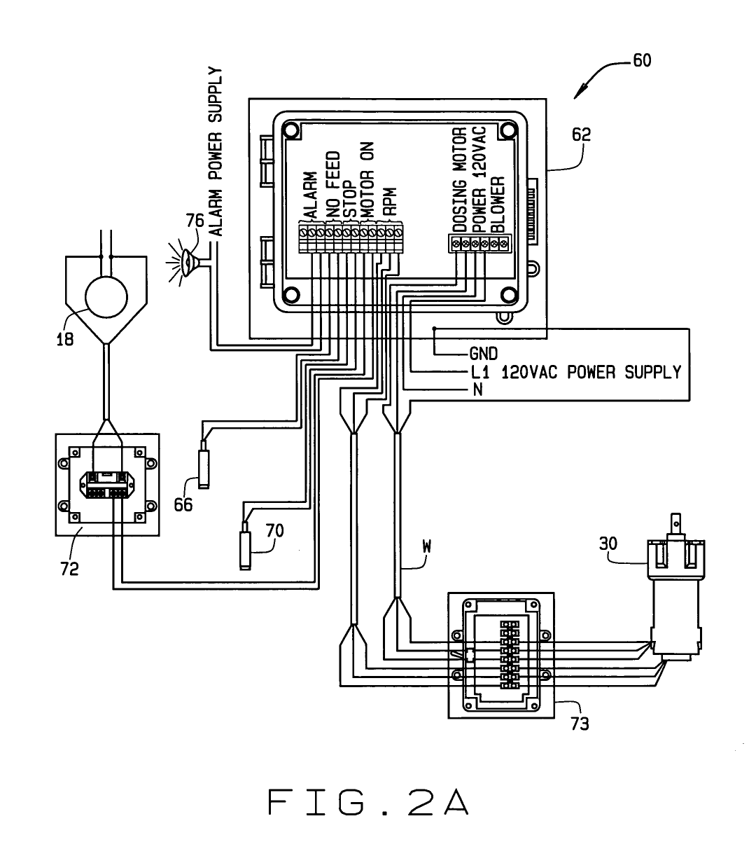

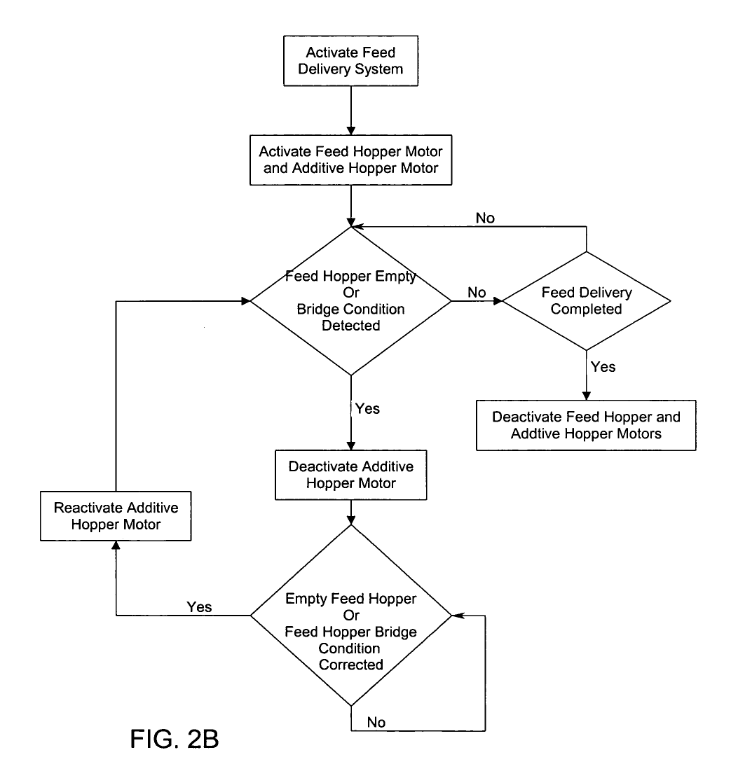

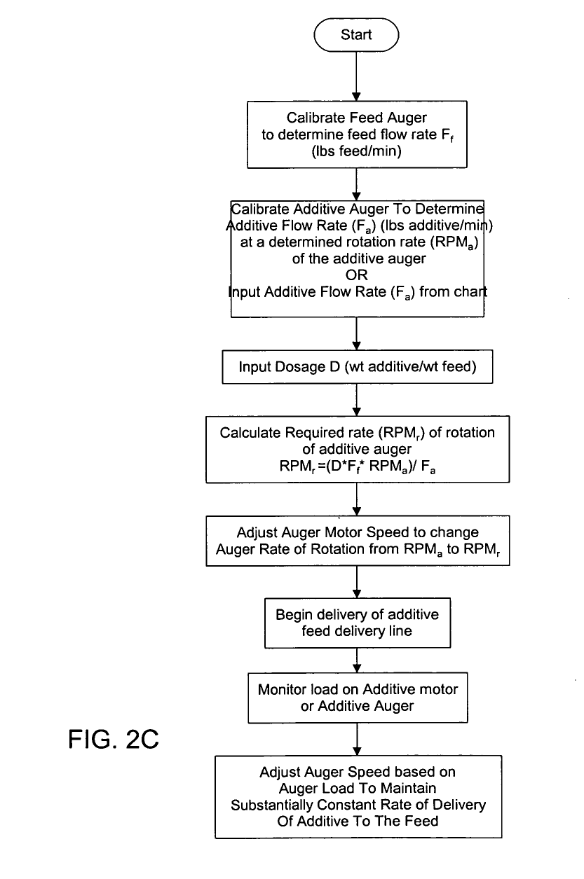

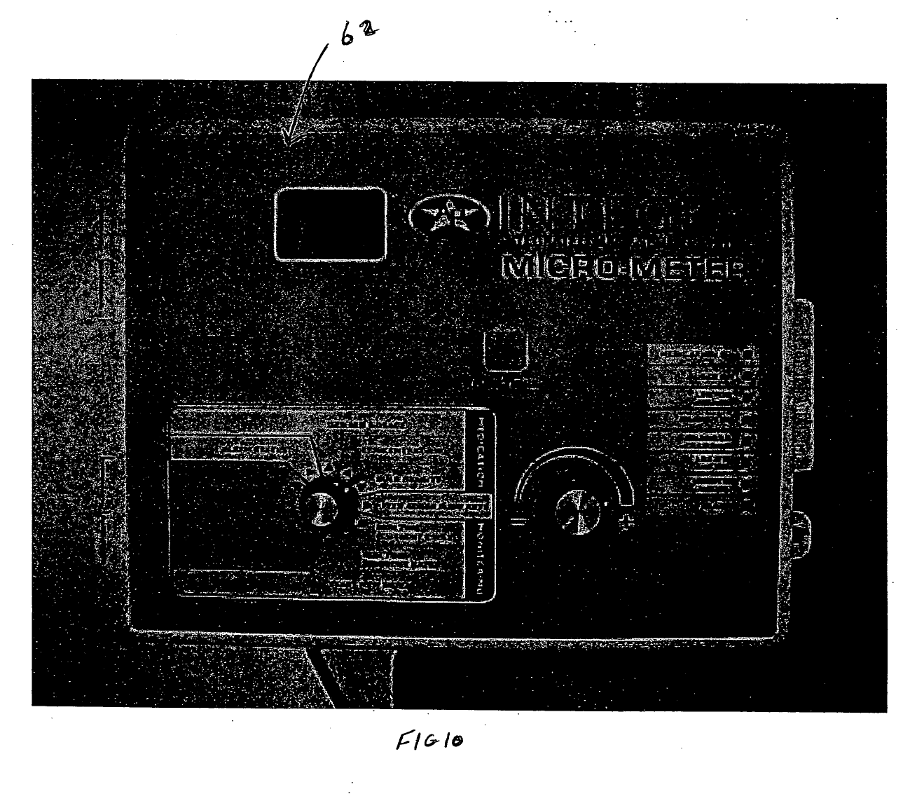

Lastly, the system 10 includes a control system 60 (FIGS. 2 and 2A) for controlling the rate of delivery of additive into the feed. The control system 60 includes a control panel 62 (shown in FIG. 10) in which is housed a control board or CPU 63. The control panel 62 is preferably positioned inside a structure to protect the panel 62 from the weather. The panel 62 can be positioned inside of the animal house in which feed and additive from the hoppers 12 and 20 is to be delivered, or, it can be at a remote location, such as at an office on the farm. The panel 62 is provided with an input 64 to allow for the input of control parameters, as will be discussed below. As seen in FIG. 10, the input comprises a selector knob 64a to select parameters on the control panel and a dial 64b used to set various parameters required for the operation of the system, as described below. Proximity switches 66 and 70 are provided at the base of the feed hopper 12 and at least one of the feed bins, respectively. If desired, a third proximity switch 68 can be provided at the base of the additive hopper. The proximity switch 66 for the feed hopper 12 and the proximity switch 68 for the additive hopper 20 (if provided) detect flow, and send a signal to the CPU 63 when the respective hopper is empty or is otherwise not delivering feed or additive (i.e., when a bridge has formed within the hopper). The feed bin proximity switch 70 sends a signal to the CPU with the feed bin is full.

The control system also includes a relay switch 72 for the feed delivery tube auger motor 18. The relay switch 72 is controlled by the CPU to activate and deactivate the feed motor 18. A junction box 73 is provided to connect the additive hopper motor 30 to the CPU 63. The proximity switches 66, 68 (if provided) and 70 and the motor relay 72 are all low voltage components. Lastly, the control panel is provided with an alarm 76 and a timer/clock 78. The alarm can be an auditory and/or visual alarm and is activated by the CPU when it is determined that feed or additive is not being delivered from the hoppers 12 or 20. The timer/clock 78 is in communication with the CPU to send a signal to the CPU of elapsed time. The control panel is connected to a source of electricity via a plug wire 80. A power cord 82 extends from the control panel to the additive motor 30 to power the motor.

The CPU 63 controls the speed of the additive motor 30, and hence of the additive auger 28 based on four factors: (1) the flow rate of feed (F_{f}) in lbs./min from the feed hopper 12 to the feed bin; (2) the flowability of the additive which is determined based on an additive flow rate (Fₐ) at a determined rate of rotation (RPMₐ) of the additive auger; (3) the concentration of the active ingredient of the additive (in grams active ingredient per lb. of additive); and (4) the desired dosage (D) in grams active ingredient per ton of feed. The parameters could be provided in alternate (but equivalent) units. Thus, for example, the feed rate could be in kg/min. These parameters are input into the CPU through the input 64 on the control panel.

In setting the CPU for delivery of feed and additive to the feed bins, it is known how much feed (in pounds or kilograms) should be delivered to the feed bin and, based on the dosage, how much additive (in ounces or grams) should be delivered to the feed bin. Most additives come with dosing instructions which state how much additive needs to be added to the feed in units of lbs additive per ton of feed. Hence, the dosage D is predetermined and can be input into the CPU using the input 64. The proper rate RPMₐ at which the additive auger 28 should be driven to deliver the additive to produce a feed with the proper amount of additive will depend on the flowability of the feed and additive. Hence, a first step in beginning a feed and additive delivery process is calibrating the feed hopper and additive hopper motors. To do this, the feed auger is run for a short period of time (i.e., 5 minutes) and, based on the amount of feed delivered in this period of time, the feed flow rate (Fₐ) in lbs/min (or equivalent units) will be determined and input into the CPU using the input 64. Alternatively, the feed auger can be operated until a desired amount of feed (i.e., 10 lbs) is delivered. The determination of the feed flow rate can be manual or automatic. If the determination is manual, then the operator runs the hopper auger for the predetermined period of time, weighs the amount of feed delivered in the time period, and enters the flow rate into the CPU using the input 64. The operator can determine the actual flow rate, or input the weight and time period, and the CPU can determine the actual flow rate. If the determination is automatic, then the control system 60 is provided with an electric scale and timer which are in communication with the CPU. During calibration, the feed conveyor will deposit feed on the scale, and based on signals from the scale and the timer, the CPU will calculate the feed flow rate. Other systems or equipment for automatically determining the feed flow rate (Fₐ) can also be used. From the feed flow rate, the feed delivery time (T_{d}) (i.e., the time needed to deliver the desired amount of feed) can also be determined based on the amount of feed that needs to be delivered. This feed delivery time can be input into the timer 78 through the input 64.

Calibration of the additive auger is similarly determined. The additive hopper motor 30, as noted above, is a variable speed motor. The additive delivery rate is determined initially with the motor set at its maximum speed, the rate of which is known. The additive delivery flow rate at this high rpm is then determined in the same manner as described above for the feed. With the additive flow rate determined for the additive, the CPU can determine the weight of additive rate per revolution of the additive auger (lbs additive/rev).

Alternatively, the additive flow rate (Fₐ) can be determined from a chart, for example, as is shown in the Calibration chart below.

MATERIAL FLOW RTE CALIBRATION CHART

| | FLOW RATE CALIBRATION VALUE (lbs/10 min) | | |
|---|---|---|---|
| | Model 220 | Model 300 | Model 350 |
| Material Name | (60:1 gear ratio) | (20:1 gear ratio) | (10:1 gear ratio) |
| Aureomycin 90 | 1.11 | 3.34 | 6.68 |
| BMD 60 | 1.15 | 4.49 | 8.98 |
| Mecadox 2.5 | 0.84 | 2.53 | 5.05 |
| Paylean 9 | 0.57 | 1.7 | 3.4 |
| Pennchlor 50 | 0.97 | 2.91 | 5.82 |
| Pennchlor SP | 0.83 | 2.49 | 4.98 |
| 250 | | | |
| Pennox 100 | 1.12 | 3.36 | 6.72 |
| Tylan 40 | 0.93 | 2.8 | 5.6 |

In the above chart, the additive flow rate (Fₐ) for common additives has been predetermined for different sized additive augers 28 and tabulated in the chart. For example, the model 220 uses a 2.20″ diameter auger; the model 300 uses a 3.0″ diameter auger; and the model 350 uses a 3.5″ auger. As can be appreciated, different sized motors are used to drive the different sized augers. The additive auger/motor system used can be set using dip switches or by means of the input 64. With the proper auger/motor system selected, the operator simply needs to look up the common additive and input the appropriate value of Fₐ using the input 64. For example, if the 2.20″ diameter auger is used, and the feed is to be supplemented with Aureomycin 90, the operator would input an additive flow rate (Fₐ) of 1.11. If the chart does not include a value for the particular additive, then the additive flow rate (Fₐ) will have to be determined as set forth above. Of course, there is no requirement that the operator use the chart, and should the operator want to, s/he could calibrate the additive flow rate (Fa) as set forth above even for an additive set forth in the chart.

As noted above, the dosage D of the additive is known, and can be input into the CPU using the input 64. Thus, with the feed flow rate (F_{f}) and the additive flow rate (Fₐ) determined and input into the CPU, the CPU can determine the required rate (RPMᵣ) to introduce the proper amount of additive to the feed at the appropriate rate to obtain the required dosage as follows:
RPMᵣ=(D*F_{f})/(Fₐ/RPMₐ)=(D*F_{f}*RPM_{a)/}Fₐ

It will be appreciated that a constant might be required to adjust between units. For example, if dosage D is in lbs additive/ton feed, and the feed flow rate F_{f} is in lbs feed/min, then a constant to convert lbs additive/ton feed to lbs additive/lb feed will be required.

Using the calculated rpm for the additive auger (RPMᵣ) and the rate of the auger during calibration (RPMₐ), the CPU can determine how much the rate of rotation of the auger needs to be adjusted to reach the desired rate of rotation for the additive auger using the ratio RPMᵣ/RPMₐ. The percent reduction in speed from RPMₐ to arrive at RPMᵣ would be ((1−RPMᵣ/RPMₐ)*100). Depending on the density of the additive, the additive delivery rate per revolution can vary. Thus, at a slow rate, the additive may be more densely packed between the auger flights than at a higher rate of rotation, hence, at a slower rate, the auger may actually deliver more additive per revolution than at a higher rotation rate. Hence, if the CPU determines that an adjustment of, for example, more than 20% is required in the additive auger speed, it may be desirable to recalibrate the additive auger starting with a slower motor speed.

For example, if the feed flow rate F_{f} is determined to be 50 lbs/min, and 100 lbs of feed are to be delivered to a feed bin, then the feed delivery time T_{d} will be 2 minutes. If the additive dosage (D) is 1.75 lbs additive/ton of feed (or 0.000875 lb additive/lb feed), and at an auger revolution RPMₐ of 20 rpm, the additive feed rate Fₐ is 0.05 lb/min, then the desired auger rotation RPMᵣ will be (0.000875*50*20/0.05)=17.5 rpm. Hence, the CPU must increase the auger speed by from 20 rpm to 17.5 rpm or by (1−17.5/20)*100 or 12.5%.

After the flow rates have been determined, and the CPU has determined the required rate of rotation for the additive auger 28, the system can then be activated to start delivery of feed and additive to the feed bins. When activated, the CPU will send a signal to the feed auger motor relay 72 to activate the feed motor 18 and will activate the additive hopper motor 30. When the motors are activated, delivery of feed and additive will commence. The system is run for a predetermined amount of time necessary to deliver the required amount of feed to the feed bins, and when this time has passed, the system can be shut down. If desired, the delivery time can be input into the CPU, either by entering a determined time period (i.e., 30 minutes) or by entering a desired amount of feed to be delivered. In the latter instance, the CPU will determine the time period by dividing the amount of feed (AF) to delivered by the feed flow rate (F_{f}). That is, T_{d}=AF/F_{f}. When the feed delivery time has elapsed, as set by the timer 72, the CPU will deactivate the additive motor 30 and send a signal to the relay 72 to deactivate the feed motor 18.

During delivery of feed, the CPU will receive signals from the feed hopper proximity switch 66. If the feed hopper proximity switch 66 sends a signal that the hopper is empty (or that there is a bridge condition), the CPU 63 will deactivate the additive hopper motor 30. If a bridge condition exists, and the condition is cleared, the CPU can then reactivate the additive hopper motor 30 to continue delivery of additive to the feed bin. However, it will be appreciated that the delivery rate of the additive may need to be adjusted to account for the portion of the feed delivery time that the additive hopper was deactivated to ensure that the full amount of additive is delivered to the feed bin. Alternatively, during the period when feed is not flowing (and the additive motor 30 has been deactivated), the timer can be stopped. The timer can be reactivated once the bridge condition has been cleared, or feed otherwise begins to flow again.

If the additive hopper proximity switch 68 is provided and if it is determined that the additive hopper is empty (or that a bridge condition exists), the CPU 63 will activate the alarm 76 to alert the operator to the potential problem.

As additive is delivered from the additive hopper 20, the load of the additive on the additive auger 28 will vary, and this will affect the rate of delivery of the additive into the feed. Hence, the control system also monitors the load of the additive on the auger, and additionally adjusts the speed of the auger based on the load. The CPU monitors the load on the auger by monitoring the rotation of the motor output shaft. The motor is provided with an encoder which will create a pulse signal each time the shaft rotates. The pulse is sent to the CPU over the wires W (FIG. 2A). The CPU counts the pulsed to monitor the rate of rotation of the motor output shaft, and hence, to monitor the rate of rotation of the additive hopper auger. If the rate of rotation changes from the desired rate of rotation due to a change in the load on the motor, the CPU will alter the voltage to the motor to change the rate of rotation of the motor output shaft, and hence of the additive hopper auger. In this manner, the controller will maintain the desired rate of rotation of the additive auger to help ensure a proper rate of delivery of the additive to the feed, and hence to help ensure that the feed includes the proper amount of additive for the desired dosage. Alternatively, the control system could be provided with a load sensor positioned adjacent the additive auger or the additive auger motor, which would, for example, monitor the torque required to turn the auger at the desired rate. Another alternative would be to directly monitor the rate of rotation of the auger. The CPU 63 uses the information of the load on the motor 30 to adjust the speed of the additive motor 30 during delivery of the additive as may be necessary. By adjusting the speed of the additive auger motor based on the load on the auger, the dosage accuracy is about 95% or better during delivery of the additive.

Under certain circumstances, it is desirable to deliver additive to only the first feed pen in an animal house. When this is the case, the pen proximity switch 70 can be activated to monitor the level of feed delivered to the first pen. When the first pen has received all the feed/additive mixture, the proximity switch 70 will send a signal to the CPU 63, the CPU will deactivate just the additive hopper motor, and the alarm 76 will be activated. The farmer can then deliver feed without the additive (or with a different additive) to the remaining pens in the house.

Using the timer/clock 78, the control system also keeps track of the cycle and total run time, so that it can be determined how much additive has been mixed in with the feed and how much feed has been delivered to the bins. Although the system is not shown with a display, a display can be provided which would display information such as flow rates, dosage, remaining time or cycle time, amount of feed delivered and amount of additive delivered.

The control panel input is described above to deliver additive at a rate according to a specific dosage. However, under certain circumstances, especially with certain medications, it is desirable to alter the dosage over time. This would require that the delivery rate be varied over time. The control panel can be programmed to enable the dosage to be varied over time.

As can be appreciated, an additive delivery system is provided which allows for in-line addition of additives or supplements to the feed, thereby eliminating the need for obtaining feed/additive mixtures which are prepared in batches. As described above, the additive delivery system is controlled based on the actual flow rates of the feed, rather than upon an assigned value which may be determined, for example, from averages. Briefly, and in summary, the additive delivery system is operated by first determining the required flow rate of the additive delivery system, monitoring the load on the additive delivery system drive (i.e., the additive hopper motor), and adjusting the speed of the additive delivery system drive based on changes to the load of the drive during delivery of additive. The required flow rate of the additive delivery system is determined by first establishing an actual flow output rate of the feed delivery system and a first flow output rate of the additive delivery system. The required, or second flow output rate, for the additive delivery system is then determined based on the established flow rates of the feed and additive delivery systems and a desired dosage for the additive. The additive hopper motor is then run at this second flow rate. The step of establishing the first flow rate of the additive delivery system comprises obtaining a value from a chart of flow rates for specific additives or it can be an actual flow rate. Establishing of actual flow rates (for either the feed delivery system or the additive delivery system) can be accomplished manually or automatically. If determined automatically, an electronic timer and scale can be provided with the system to determine the actual flow rates or the flow rates can be determined on-the-fly using known flow rate measuring equipment. In either case, the automatic system would provide the established rates to the controller for determination of the second flow rate for the additive delivery system.

Additionally, the method can comprise a step of checking the actual flow rates of either or both of the feed delivery system and/or the additive delivery system. If the flow rate of either the feed delivery system or the additive delivery system has changed, the speed at which the additive delivery system drive is operated can be adjusted to compensate for the changes to (1) maintain the second flow rate of the additive delivery system at a substantially constant rate and (2) to ensure that the proper additive dosage is maintained.

The monitoring of the load, as noted above, is accomplished by monitoring the speed of rotation of the additive motor output shaft. This rate of rotation is directly convertible into a rate of rotation of the additive hopper auger based on the gear reduction ratio between the auger and the motor output.

Although the system is described using a single additive hopper 20, it will be appreciated that two or more additive hoppers can be provided to allow for the blending of multiple additives into the feed line 16. Additionally, the additive hopper 20 can be provided to deliver additive to multiple feed lines, rather than to a single feed line as shown in the Figures.

As various changes could be made in the above constructions without departing from the scope of the invention, it is intended that all matter contained in the above description or shown in the accompanying drawings shall be interpreted as illustrative and not in a limiting sense. For example, although augers are preferred for the delivery of feed to the feed bins and for delivery of additive to the drop tube 32, the augers could be replaced with other conveying means. The additive auger 28 of the additive hopper 20 could be replaced with a different additive release device. For example, if the outlet were positioned centrally at the bottom of the additive hopper (for example if the hopper 20 had a conical bottom), the auger could be replaced with a rotating plate which would release additive from the hopper at a desired rate. Alternatively, a horizontally positioned additive tube could be placed beneath the additive hopper 20, and such an additive tube could be provided with an auger. In this instance, the drop tube 32 would extend between this additive tube and the feed delivery tube 16. Although the system as described provides for adjustment of the additive hopper motor based on the feed delivery rate, the feed auger motor could be a variable speed motor, and, if desired, the rate of the feed auger could be adjusted based on the delivery rate of the additive hopper. While the rates of rotation of the additive hopper are denoted as RPM (or revolutions per minute), the rates of rotation could be calculated in other time units if desired. Although the description above refers to the rates of rotation of the feed auger and the additive auger, it will be apparent that the rates of rotation could also be the rate of rotation of the output shafts of the feed motor and the additive hopper motor. These examples are merely illustrative.

1. A feed additive hopper assembly comprising:
an additive hoper having front, back and side walls, an opening at a top thereof, an outlet at the bottom thereof;
an outlet tube having a first end in fluid communication with said hopper outlet, said outlet tube having a first end operatively connected to said hopper outlet and a second free end; said free end being capable of being placed in fluid communication with a feed tube;
a mounting bracket for mounting said hopper to a surface; said bracket being adapted to be mounted to a surface and having a pair of opposed arms; said hopper being pivotally mounted to said bracket arms.

2. The hopper assembly of claim 1 wherein said hopper is pivotal between a first position in which the hopper is upright and a second position in which the hopper is inverted.

3. The hopper assembly of claim 1 including a lock; said lock extending through said bracket arm to operatively engage said hopper; said lock being movable between a first position in which said lock engages said hopper to secure said hopper in a desired position, and a second position in which said hopper can be pivoted in said bracket.

4. The hopper assembly of claim 3 wherein said lock comprises a rotatable knob having a shaft, whereby rotation of said knob in a first direction moves said lock from said first position to said second position and rotation of said knob in a second direction moves said lock from said second position to said first position.

5. The hopper assembly of claim 1 including a pivot plate connected to opposite sides of said hopper and a pin extending through said bracket arm and said pivot plate; said pin defining an pivot axis for said hopper.

6. A feed additive hopper assembly comprising:
an additive hoper having front, back and side walls, an opening at a top thereof, an outlet at the bottom thereof;
an outlet tube in fluid communication with said hopper outlet, said outlet tube having a first end connected to said hopper outlet and a second free end; and
a connector assembly at said tube free end; said connector being sized and shaped to connect said hopper tube to a feed delivery tube of a feed delivery system and place said outlet tube, and hence said additive hopper, in fluid communication with said feed delivery tube;
wherein said feed delivery tube is removably connected to at least one of said connector and said additive hopper outlet.

7. The hopper assembly of claim 6 wherein said connector assembly comprises a saddle sized and shaped to be fitted over the feed delivery tube of a feed delivery system.

8. The hopper assembly of claim 7 wherein said saddle is generally C-shaped in end elevation; said saddle being sized and shaped to be snap fit over the feed delivery tube.

9. The hopper assembly of claim 6 wherein said connector assembly and said hopper outlet each comprise necks; said outlet tube being sized and shaped to mate with said connector assembly and outlet necks.

10. A feed delivery system comprising a feed hopper, a feed delivery tube extending from said feed hopper to a feed bin, a feed conveyor carried by said feed tube, a feed conveyor drive, at least one feed additive hopper, an additive conveyor, an additive conveyor drive, and an additive tube extending from said additive hopper to said feed delivery tube; said feed delivery tube being of a sufficient length and said feed conveyor being sized and shaped such that said additive is thoroughly mixed with said feed at an outlet from said feed delivery tube.

11. The feed delivery system of claim 10 wherein said feed additive hopper comprises front, back and side walls defining a volume to receive an additive, an opening at a top of said additive hopper, and an outlet at the bottom of said additive hopper;
said additive tube being in fluid communication with said additive hopper outlet; said additive tube having a first end operatively connected to said hopper outlet and a second free end; and
a connector mounted to said feed tube; said additive tube being removably connected to at least one of said connector and said hopper outlet.

13. The feed delivery system of claim 12 wherein said additive tube connector is sized and shaped to be snappingly received on said feed delivery tube.

14. The feed delivery system of claim 10 further comprising a mounting bracket for mounting said additive hopper to a surface; said bracket having a base plate and a pair of opposed arms extending from said base plate; said arms being operatively connected to opposite walls of said additive hopper to support said additive hopper; said additive hopper being pivotally mounted in said bracket.

15. The feed delivery system of claim 14 wherein said additive hopper is pivotal between a first position in which the hopper is upright and a second position in which the additive hopper is inverted.

16. The feed delivery system of claim 10 comprising a control system for controlling the delivery of additive and feed from said additive hopper and feed hopper to said feed bin; said control system comprising:
a controller adapted to monitor the load of said additive hopper motor;
whereby, said controller adjusts the rate of rotation of said additive auger based on the signal received from said additive hopper load sensor to maintain a substantially constant rate of delivery of said additive to said feed.

17. The feed delivery system of claim 16 wherein said control system includes:
a feed hopper sensor which sends a signal to said controller when it is determined that said feed hopper is empty or that a bridge condition exists in said feed hopper; and
when said controller receives a signal from said feed hopper sensor said controller deactivates said additive delivery mechanism drive.

18. The feed delivery system of claim 17 including a feed bin sensor which sends a signal to said controller when it is determined that said feed bin is full; said controller deactivating both said feed conveyor drive and said additive conveyor drive upon receipt of a signal from said feed bin sensor.

19. In a feed delivery system for an agribusiness, the feed delivery system comprising a feed hopper, a feed bin, a feed delivery path between said feed hopper and feed bin containing a conveyor to transfer feed from said feed hopper to said feed bin; an additive hopper in communication with said feed path; and an additive conveyor operatively positioned between said additive hopper and said feed path to deliver additive from said additive hopper to said feed path; the improvement comprising a method of controlling the rate of delivery of additive into the feed to achieve a desired dosage D of said additive; the method including;
determining a desired speed RPMᵣ of said additive motor based upon a flow rate F_{f} of the feed from the feed hopper to the feed bin;
driving the additive motor at said desired speed RPMᵣ;
monitoring the load on said additive motor; and
adjusting the speed of said additive motor based upon changes in the load of said motor to maintain a substantially constant rate of delivery of additive to said feed.

20. The method of claim 19 wherein the step of determining the speed RPMᵣ of said additive motor comprises:
a. determining a flow rate F_{f} of said feed from said feed hopper to said feed bin in units of wt/time;
b. determining a flow rate Fₐ of said additive from said additive hopper in units of wt/time at a predetermined speed RPMₐ of said additive motor; and
c. determining RPMᵣ based on the formula RPMᵣ=(D*F_{f}*RPMₐ)/Fₐ.

21. The method of claim 20 wherein said step of monitoring the load on said feed motor comprises monitoring the electrical current used by said motor to drive the additive conveyor.

22. The method of claim 20 wherein the step of monitoring the load on said feed motor comprises monitoring the torque required by said motor to drive said additive conveyor.

23. The method of claim 20 wherein the step of monitoring the load on the feed motor comprises monitoring the rate of movement of additive feed conveyor.

24. A controller system for an in-line supplement delivery system for adding a supplement to a feed line of a feed system; the feed system comprising a feed hopper; at least one feed bin; said feed line carrying a conveyor to deliver feed from said feed hopper to said feed bin; a feed motor adapted to drive said feed conveyor; an additive hopper in fluid communication with said feed line; a conveyor for delivering supplement from said additive hopper to said feed line; and an additive drive adapted to drive said additive conveyor; said controller comprising:
a CPU; said CPU being in communication with said feed motor and said additive motor to activate and deactivate said feed and additive motors;
a feed sensor in proximity to said feed hopper; said feed sensor being in communication with said CPU and emitting a signal when it is determined that feed has stopped flowing from said feed hopper;
whereby, when said CPU receives a signal from said feed sensor indicative of the stoppage of flow of feed from said feed hopper said CPU deactivates said additive motor.

25. The controller of claim 24 wherein, after said CPU deactivates said additive motor, said CPU reactivates said additive motor upon receipt of a signal from said feed hopper sensor that feed has begun flowing again.

26. The controller of claim 24 including a feed bin sensor in communication with said CPU, said feed bin sensor emitting a signal to said CPU when said feed bin is full; said CPU deactivating at least said additive motor upon receipt of a signal from said feed bin sensor.

27. The controller of claim 24 wherein said CPU monitors the load on said additive motor; said CPU controlling the speed of said additive motor based upon the load on said additive motor.

28. A method of controlling an in-line supplement delivery system for adding a supplement to a feed line of a feed delivery system; the feed delivery system comprising a feed hopper; at least one feed bin; said feed line carrying a conveyor to deliver feed from said feed hopper to said feed bin; a feed motor adapted to drive said feed conveyor; an additive hopper in fluid communication with said feed line; a conveyor for delivering supplement from said additive hopper to said feed line; and an additive drive adapted to drive said additive conveyor; the method comprising:
a) determining an actual flow output rate of the feed delivery system;
b) establishing a first flow output rate of the additive delivery system;
c) determining a second flow output rate for the additive delivery system based on the established flow rates of the feed and additive delivery systems and a desired dosage for the additive.

29. The method of claim 28 wherein the step of establishing the first flow rate of the additive delivery system comprises obtaining a value from a chart of flow rates for specific additives.

30. The method of claim 28 wherein the step of establishing the first flow rate of the additive delivery system comprises establishing an actual flow rate of the additive delivery system.

31. The method of claim 30 wherein the step of establishing the actual flow output rate of the feed delivery system and/or the additive delivery system is determined manually or automatically.

32. The method of claim 31 wherein the step of automatically determining the actual flow output rate of the feed and/or additive delivery systems comprises measuring the flow rate on the fly; determining the amount of material output by the delivery system in a predetermined period of time; or determining the time for outputting a predetermined weight of material.

33. The method of claim 30 comprising a step of checking the actual flow output rates of the feed delivery system and/or the additive delivery system.

34. The method of claim 33 comprising a step of adjusting the second flow output rate for the additive delivery system if the flow output rate for the feed delivery system has changed.

35. The method of claim 30 comprising a step of monitoring the load on the additive conveyor drive and adjusting the speed of the additive conveyor drive to maintain the second flow output rate for the additive delivery system substantially constant.

36. A method of controlling an in-line supplement delivery system for adding a supplement to a feed line of a feed delivery system; the feed delivery system comprising a feed hopper; at least one feed bin; said feed line carrying a conveyor to deliver feed from said feed hopper to said feed bin; a feed motor adapted to drive said feed conveyor; the supplement delivery system comprising an additive hopper in fluid communication with said feed line; a conveyor for delivering supplement from said additive hopper to said feed line; and an additive drive adapted to drive said additive conveyor; the method comprising:
determining a desired flow rate of the supplement delivery system based on the actual flow rate of the feed delivery system and the dosage of the additive;
driving the additive drive at a speed to achieve the desired flow rate of the supplement delivery system;
monitoring the speed of the additive drive; and
adjusting the speed of said additive drive based upon changes in the speed of the drive.

37. The method of claim 36 comprising a step of monitoring the flow rate of the feed delivery system and adjusting the flow rate of the additive delivery system based upon changes in the flow rate of the feed delivery system.

38. The method of claim 36 comprising a step of monitoring the flow rate of the additive delivery system and adjusting the speed of the additive drive in response to changes in the flow rate of the additive delivery system in order to maintain a substantially constant flow rate of additive.
